(19) United States
(12) Patent Application Publication
(10) Pub. No.: US 2006/0052168 A1
(43) Pub. Date: Mar. 9, 2006

(54) System method and platform for online gaming

(75) Inventor: Noa Shacham, New York, NY (US)

Correspondence Address: Martin Moynihan;Anthony Castorina, Suite 207, 2001 Jefferson Davis Highway, Arlington, VA, 22202, US

(73) Assignee: Sabian Group Inc., Road Town (VG)

(21) Appl. No.: 10/542,297

(22) PCT Filed: Jan. 18, 2004
(86) PCT No.: PCT/IL04/00049

§ 371 Date: Jul. 15, 2005

(30) Foreign Application Priority Data
Jan. 16, 2003 (US) 60440353

(51) Int. Cl. G06F 19/00

(52) U.S. Cl. 463/42

(57) ABSTRACT

A monetary or non-monetary online gaming platform, for enabling online games, gambling, events: activities and/or entertainment, comprising a transaction server, database may be associate with a plurality of event generators. The transaction server may simultaneously receive information from a plurality of event generators, thereby enabling players to simultaneous monitoring multiple events, and bid on a plurality of gaming events and/or derivatives of those events.

### FIELD OF THE INVENTION

The present invention relates generally to the field of gaming, and more particularly to online gaming, applications for online gaming, platforms and methods.

### BACKGROUND OF THE INVENTION

Electronic gaming, which generally refers to user participation in entertainment or gambling games, has-been revolutionized as a result of the proliferation of global Internet access. As with many other industries, the gaming industry has become increasingly network-friendly, thereby enabling players to partake in gaming events from their personal computers, wherever the player may be, and at all times. Online (Internet based) gaming has consequently become an extremely popular activity, with millions of users logging into gaming sites daily in order to participate in one or a variety of games from their personal computers.

One major segment of online gaming is chance-based gaming, wherein players place bets on uncertain outcomes. An example of a long time popular form of chance-based gaming is gambling, which is typically conducted between one or more players and a party against who they wager, typically referred to a the House, where the House may control the betting, game management and transactions. Online implementations of gambling have also thrived due to the proliferation of Internet access. Existing implementations of online gambling may include typical gaming elements, such as one or more users and the House, as well as network based computing devices, by means of which the users may interact with each other and with the House. Such online gambling operations generally enable users to choose a game, enter the game by either downloading a computer application or through a web browser, place bets on one or more possible outcomes of a random or semi-random computer generated event, and make or lose points or money according to the outcome of the bets. With most online gaming of the prior art, the computer application or web site through which a player bets is completely controlled by the House. The House is in control of both managing the game and all associated transactions, and may also control the outcome of a supposedly random event generator (e.g. computer roulette table) on which a player places their bet.

U.S. Pat. No. 5,800,268, which is incorporated herein by reference in its entirety, describes a method of participating in a live casino game from a remote location. The '268 invention enables a player to participate in a live casino game and to place bets from a location remote from the casino at which the game is being played. Basically, the '268 patent describes a one-way teleconferencing system between a player and a single land based casino.

There are no known prior art gaming “systems which have separated transaction management and game event generation. There are no prior art gaming systems which may allow a player to concurrently participate in multiple games running on multiple independent game event generators (e.g. roulette tables) located at different and distinct physical and/or virtual locations.

Thus, it would be highly advantageous to have, an application, a system and a method that would enable garners to monitor, analyze and play a plurality of separate games simultaneously through a single application, web browser, set of applications, or set of browsers.

Furthermore, it would be highly advantageous to have, a system and method that would enable a virtual house to simultaneously monitor, track and accept bets relating to one or more physical and/or virtual events associated with one or more event generators.

### SUMMARY OF THE INVENTION

The present invention provides a monetary or non-monetary online gaming platform, for enabling online games, gambling, events, activities and/or entertainment, that overcomes the limitations of existing land based and online gaming systems. The present invention provides a platform and method that may separate the actual event, produced by an event generator, and a Web server (i.e. transaction server), that may communicate with both a player and one or more event generators and may processes the event data such that a player may place bets on the outcome of one or more event generators. This separation, together with the integration of additional server components, may enable a network-based game management center, (hereinafter referred to as a “virtual House” or just “House” to monitor the results of events from a plurality of event generators in real time, and manage data streams from one or more event generators simultaneously, whether the events are land-based and/or network-based (virtual) in nature.

One or more players, or groups of players, such as consumer groups, may monitor, analyze and play one or more events related to one or more event generators. The event generators may be any chance or skill based games known today or to be devised in the future, for example, but without limitation, a computer application simulating a roulette table, a real roulette table, a computer application simulating a slot machine, a real slot machine, a computer application simulating a chance-based game, a real chance-based game, a computer application simulating a blackjack game, a real blackjack game, a computer application simulating a baccarat game, and a real baccarat game.

According to at least one embodiment of the present invention, an event monitor such as a digital reader may be connected to, or associated with, one or more event generators and may digitize and/or transmit to a transaction server data indicative of events which may occur on the one or more event generators. According to further embodiment of the present invention, image and/or video information, digital or analog, May be collected from or near at lease one event generator, and a pattern recognition unit may analyze image and/or video information from one or more event generators and the pattern recognition unit may produce a signal indicative of events which may occur on the one or more event generators. Image and/or video information may be collected and transmitted via analog and/or digital communication channels, wire based, wireless, or by any other means known today or to be devised in the future. The image and/or Video information may be collected by a video camera, web-cam, still digital camera, or any other device or system known today or to be devised in the future.

According to some embodiments of the present invention, the image and/or video information collection device (e.g. video camera) may be controlled by a computer associate with the pattern recognition unit such that device is positioned and focused onto those areas of the one or more event generators most relevant at a given moment in a game. For example, during the time bets are places on a roulette table, the image/video collection device may be positioned so as to acquire; clear images of the roulette table's bet placing area, and during the spin of the ball, the camera may be repositioned to get a clear view of the ball and the number where the ball lands. According to further embodiments of the present invention, the image/video collection device may be operated and/or controlled manually, possibly through a monitoring and control station, either locally or remotely.

There is provided, in accordance with at least one embodiment of the present invention, an application, system and method for automated conversion of video based gaming data, or data from a digital reader into usable statistical data, thereby enabling one or more players to participate in games while using both historic and real time gaming information from one or more games and/or event generators, whether the games are online or offline (land based). As part of some further embodiment's of the present invention, part or all of a specific player's playing history may be recorded and statistics relating the player's gaming activities may be compiled and presented to the player on demand. A player may define the format in which the statistics are to be compiled and presented, and the player may thus use these statistics in making future gaming decisions or developing a gaming/betting strategy.

There is also provided, in accordance with at least one embodiment of the present invention, a transaction server or system upon which players may place bets based on the outcomes of one or more specific events. These bets may be based on standard game results or on alternative elements or derivatives related to the game progress or results. For example, a player may bet on future spins of a roulette table, a set of future spins on a roulette table, or on one or more sets of spins on one or more sets of roulette tables, or any other combination of game events occurring on the same or independent game event generators.

According to some embodiments of the present invention, a player may instruct a virtual betting agent to monitor one or more event generators and upon one or a set of events taking place, to place one or more bets associated with one, or more game event generators. According to further embodiments of the present invention, a player may place a bet on some combination of game events occurring on one or a combination of game event generators, either over some period of time or over some number of games.

According to some embodiments of the present invention, the transaction server may include a risk management unit which may stop or terminate the acceptance of bets from players on one or more game events associated with one or more event generators when it is determined that exposure to potential losses by the House exceeds some threshold value. Different risk management units may apply to different groups of player and different groups of event generators.

### BRIEF DESCRIPTION OF THE DRAWINGS

The present invention will be understood and appreciated more fully from the following detailed description taken in conjunction with the appended drawings, it being understood that these drawings are given for illustrative purposes only and are not meant to be limiting, in Which:

FIG. 1 is a diagram illustrating some components of an online gaming platform according to at least some embodiments of the present invention;

FIG. 2 is a diagram illustrating some components of a transaction server according to some embodiments of the present invention;

FIG. 3 is a flowchart illustrating steps which may be performed according to one or more methods associated with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Furthermore, usage of the word “gaming”, “gambling” or the like, refer to either land-based or online events, activities, games, sessions, rounds, hands, rolls and operations etc., including video games, Web games, casino games, card games, dice games, sporting events and/or any other gaming or gambling events. In addition, the word “bet”, “bid” or the like, refer to any type of wagers, bets or gaming ventures that are placed on random events, whether of monetary or non-monetary value.

The platforms, processes and displays presented herein are not inherently related to any particular computer or other apparatus. Various general-purpose computing systems and networking equipment may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the present invention as described herein.

In the following detailed description, numerous specific details are set forth in order to provide a thorough understanding of the present invention. However, it will be understood by those skilled in the art that the present invention may be practiced without these specific details. In other instances, well-known methods, procedures and components have not been described in detail so as not to obscure the present invention.

The present invention provides-a monetary or non-monetary online gaming platform, for enabling online games, gambling, events, activities and/or entertainment, that overcomes the limitations of existing land based and online gaming systems. The present invention provides a platform and method that may separate the actual event, produced by an event generator, and a Web server (i.e. transaction server), that may communicate with both a player and one or more event generators and may processes the event data such that a player may place bets on the outcome of one or more events produced by one or more event generators. This separation, together with the integration of additional server components, may enable a network-based game management center, (hereinafter referred to as a virtual House” or just “House” to monitor the results of events from a plurality of event generators in real time, and manage data streams from one or more event generators simultaneously, whether the events are land-based and/or network-based (virtual). One or more players, or groups of players, such as consumer groups, may monitor, analyze and play one or more events related to one or more Event generators.

According to at least one embodiment of the present invention, an event monitor such as a digital reader may be connected, associated with, and or otherwise collect data from one or more event generators and may digitize and/or transmit to the transaction server data indicative of events which may occur on the one or more event generators. According to further embodiment of the present invention, image and/or video information, digital or analog, may be collected from or near an event generator, and a pattern recognition unit may analyze the image and/or video information from one or more event generators such that the pattern recognition unit may produce a signal indicative of the events which may have occurred on the one or more event generators. Image and/or video information may be collected and transmitted via analog and/or digital communication channels. The image and/or video information may be collected by a video camera, web-cam, still digital camera, or any other suitable device or system known today or to be devised in the future.

According to some embodiments of the present invention, a person or persons may monitor a game event generator and may manually enter and/or transmit game event data to the transaction server. According to some embodiments, the image and/or video information collection device (e.g. video camera) may be controlled by a computer associate With the pattern recognition unit such that the device is positioned and focused onto those areas of the one or more event generators most relevant at a given moment. For example, during the time bets are places on a roulette table, the image/video collection device may be positioned so as to acquire clear images of the roulette table's bet placing area, and during the spin of the ball, the camera may be repositioned to get a clear view of the ball and the number where it lands.

There is provided, in accordance with at least one embodiment of the present invention, an application, system and method for automated conversion of image and/or video based gaming data, or data from a reader, digital or analog, into usable statistical data, thereby enabling one or more players to participate using both historic and real time gaming information from one or more games and/or event generators, whether the games are online or offline (e.g. land-based). According to further embodiments of the present invention, statistics may be compiled from game event-data collected, whether the data was collected manually through automated means such as a digital reader, video collection device, or the like.

As part of some further embodiments of the present invention, part or all of a specific player's playing history may be recorded and statistics relating to the player's gaming activities may be compiled and presented to the player on demand. A player may use these statistics in making future gaming decisions or developing a gaming/betting strategy.

There is also provided, in accordance with at least one embodiment of the present invention, a transaction server or system for players to place bets based on the outcomes of one or more specific games, whether the games are physical or virtual. These bets may be based on standard game results or on alternative elements or derivatives related to the game progress or results. For example, a player may bet on future spins of a roulette table, a set of future spins on a roulette table, or on one or more sets of wins on one or more sets of roulette tables, or any other combination of game events occurring on the same or independent game Event generators. It should be understood by one or ordinary skill in the art the present invention is not limited to roulette, but may amply to any games or game event generators, presently known or to be devised in the future, for example, but without limitation: a computer application simulating a slot machine, a real slot machine, a computer application simulating a chance-based game, a real chance-based game, a computer application simulating a blackjack game, a real blackjack game, a computer application simulating a baccarat game, and a real baccarat game.

According to some embodiments of the present invention, a player may instruct a virtual betting agent to monitor one or more event generators and upon one or a set of events taking places to place one or more bets associated with one or more game event generators. According to further embodiments of the present invention, a player may place a bet on some combination of game events occurring on one or more game event generators, either over some period of time or over some number of games or game events.

According to some embodiments of the present invention, the transaction server may include a risk management unit which may stop or terminate the acceptance of bets from players on one or more game events associated with one or more event generators when it is determined that exposure to potential losses by the House exceeds some threshold value. Different risk management units may apply to different groups of player and different groups of event generators.

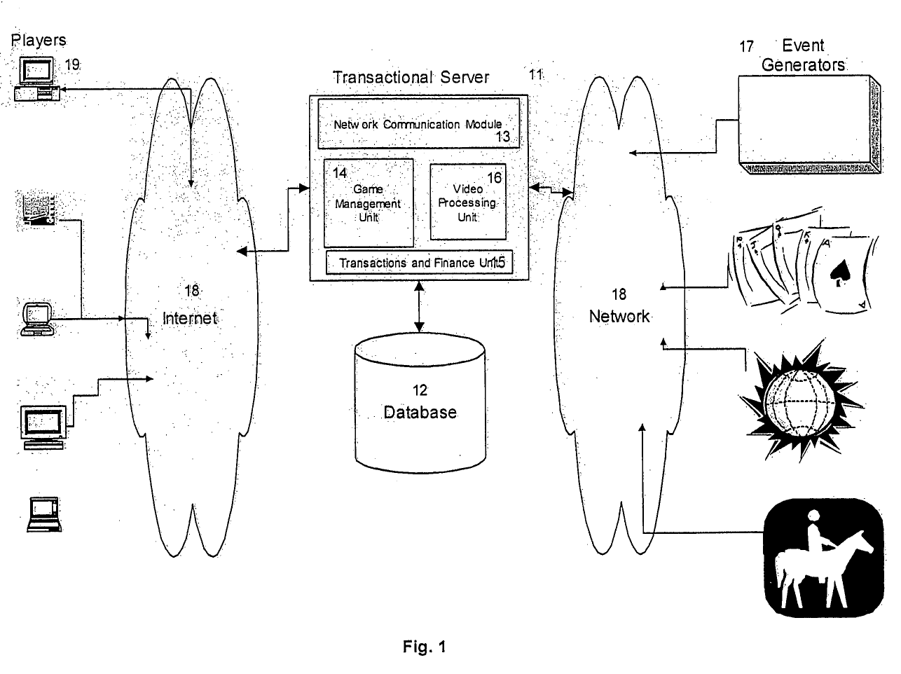

Specifically, reference is now made to FIG. 1, which is a monetary or non-monetary online gaming platform or system, generally designated 10 according to at least one embodiment of the present invention, for enabling online games, gambling, events, activities and/or entertainment. In FIG. 1 is shown a Transaction server (TS) 11, operationally connected to at least one database 12. The database 12 may store player account data, game data for each gaming event (from all the Event generators, which are described below), player activity and history data, player participation data, player preferences data, House data, and any other data that is relevant for performing the operations of the platform 10. The TS 11 is also operationally connected to at least one Event generator (“EG”) 17, such as a land-based (physical) or online (virtual) video game, computer game, chess game, bingo game, roulette table, blackjack table, one-arm bandit machine or sporting game or any other game, entertainment event and/or gambling event that typically produces a random or indefinite result that may be bet or bid on. An EG may include a mechanism for maintaining, monitoring, implementing or otherwise generating events, as well as a mechanism for enabling transmission of event data relating to individual events (games/tables/machines etc.) to the TS 11. This data may be in the form of data signals that transmit game results, audio streams; images, video streams of actual event recordings, or any other data format that represents monitored events. The EG 17 may include data reading and transmission tools, devices or systems to transmit event data. Such tools may include electronic or mechanical mechanisms to read analog and/or digital data generated by the EG 17, and transfer this data to the TS, 11. Other examples of such a data reading devices may include optical readers, commonly known in the art, that are typically used in roulette tables, and or Video cameras. A video camera or any alternative reader may transmit data digitally either over a digital channel or over an I.P. network using digital packets.

The TS 11 may be connected to an EG 17 through a wireline and/or is wireless data network, such as the Internet 18, a company Intranet, and/or Extranet, using communications mediums including cable TV networks, satellite networks and cellular communication networks. Such network connectivity may enable interactive communications between players 19, the platform 10 and the Event generator(s) 17. According to an alternative embodiment of the present invention, the EG(s) 17 may be geographically connected to the TS 11, such as in the case where the EG(s) 17 are virtual (computerized) EG(s) connected to the TS 11. Players according to some embodiments of the present invention, may interact with the platform using any type of computing and/or communication device, including personal computers, PDAs, mobile telephones, interactive TV, wearable computers, notebook computers, etc.

Transaction server (“TS”) 11, according to some embodiments of the present invention, may provide a platform and system that may separate an actual event, produced by an Event generator, and the server, that communicates and processes the event data (Transaction server). This separation, together with the integration of additional server components, enables the implementation of a virtual House that h monitor the results of events from a plurality of Event generators (in real time), and manage the data from one or more Event generators simultaneously, whether the events that have been generated are land-based and/or virtual. The House subsequently may enable one or more players, or one or more groups of players, such as consumer groups, to monitor, analyze and wager on one or more events produced by one or more EGs simultaneously, whether the events are land-based and/or virtual. The House furthermore may enable one or more players to monitor and interact with one or more external activities, events or gaming sessions (hereinafter referred to as “events”), and “play” these events with the House and/or one or more other players.

The above stated functions of the TS 11 may be achieved by receiving event data from one or more EGs 17 and directing the event data to the various components of the TS 11, to the database 12 and to the players 19. Event data may be in the form of data signals representing event results of individual events, or actual recorded data streams, such as video streams, that capture the actual events. In this way players are able to monitor and interact with a plurality of external games or events simultaneously. Players 19, according to the present invention, may be operating any network enabled interactive computing or communications device. The present invention, furthermore, enables a plurality of players to play against the House, to play against each other, or to form teams whereby the teams may play against each other and/or against the House.

According to some embodiments of the present invention, one player or group of players may bear the financial risk for the bets of another player or group of players. In some games according to some embodiments of the present invention, where players compete against each other, for example poker, each player or team of players may bet against each other. In other games, a player or group of players may act as the House for another group of players, where the group representing the house may benefit from the losses of the second group and may be responsible for payment resulting from the wins of the second group.

The TS 11 may further contain a Network Communication Module (NOM) 13, with server functionality, for receiving and transmitting data between the TS 11 and Event generators (EG) 17, and between the TS 11 and the players 19. The NCM 13 may include a security layer for enabling (secure) communication of data to and from the TS 11. The security layer may incorporate relevant security hardware and/or software for protecting data against unauthorized access and keeping the network secure from intruders etc.

The TS 11 may further contain a Game Management Unit (GMU) 14 for managing various operations within the TS 11, and for enabling interaction between the TS 11 and the EG(s) 17, and between the TS 11 and the players 19. The GMU 14 may also provide a graphic user interface (GUI) that presents event data to the players and enables the players to monitor progress of relevant events, manage accounts, and give commands to the TS 11, such as bidding preferences and rules. According to a further embodiment of the present invention, the GUI may provide a split screen that divides the player's display device (which may include a PC monitor, interactive TV screen, cellular phone panel, PDA screen or any other display device) into several windows, each one displaying the progress, results and/or statistical data for at least one individual game. Such a GUI may thereby simultaneous provide viewing, analyzing, bidding and/or managing options to a player over a plurality of games or events.

In addition, the TS 11 may include a Transactions and Finance Unit (TFU) 15, for managing of players accounts as well as authentication and implementation of financing and payouts etc. for players. The TFU 15 may be adapted to support any financial systems and payment methods, including online (Internet based) accounts, credit card accounts, token accounts, ATM accounts, e-bank accounts, or any other player accounts, whether “money” based or “non-money” based accounts. According to at least one embodiment of the present invention, the TFU 15 may request initial deposits (of money or tokens etc.) in a account. The TFU 15 may verify that the deposit satisfies House rules. Examples of such House rules relating to deposits include but are not limited to: minimum and maximum deposit amount, authentication of the depositor identity and eligibility, and any other deposit related rules and/or regulations determined by the House. Once this deposit has been made, the account may then be credited or debited in real time, according to the bids placed by players or payouts received by players. According to this embodiment, each bid or wager made may be verified by the TFU 15, which queries the player account before confirming a bid, to determine available resources to cover the cost of the bid.

According to a further embodiment of the present invention, the TS 11 may be operationally connected to a player's financial institution, credit/debit card account, e-bank, credit-card processing center or any other financial transaction center. This embodiment may enable player participation with the platform 10, while the platform 10 is indirectly connected to the player's account. In this way, the TFU 15 may manage each player's online account, including, but not limited to, the following functionalities: verifying player identity; authenticating financial ability of players; securing payments for bids; and implementing deposits of payouts etc.

According to an additional embodiment of the present invention, in the case where EG 17 is equipped with multicasting software, the TS 11 may enable a player 19 to configure the platform 10 to route video event data or other game data from: EG 17 directly to at least one player 19. In this way, video data or alternative gaming data may be received and processed by one or more players 19, in addition to (but not necessarily by) the TS 11.

According to a further embodiment of the present invention, the TS 11 may contain a Video Processing Module (VPM) 16 that may enable processing of video data received from EG 17. This VPM 16 may incorporate a video recognition module together with video data analysis software, thereby enabling the VPM 16 to recognize, filter, format and/or analyze etc. raw video data streams from one or a plurality of EG(s) 17, thereby converting such raw data into player-usable data. Any data recognition and conversion tool may be used for this purpose. An example of such a data recognition and formatting tool has been described in U.S. Pat. No. 6,339,773, which is incorporated by reference in its entirety. The '773 patent describes a tool for converting data from a received format into another chosen format, and subsequent transmitting or embedding the format. Where necessary, this tool also describes reformatting the data in its original format. Such video data from EG 17 may alternatively be acquired directly from a security apparatus such as security video cameras that are located in close proximity to an individual event generator. An example of such video-based security apparatus is the NiceVision series of applications, from NICE Systems Ltd. (NICE Systems Ltd., 8 Hapnina Street, P.O Box 690, 43107 Ra'anana, ISRAEL.

According to a further embodiment of the present invention, the TS 11 may contain an Audio Processing Module (APM) that enables processing of audio data received from EG 17. This APM may incorporate an audio recognition module together with audio data analysis software, thereby enabling the APM to recognize, filter, format and/or analyze etc. raw audio data streams from a plurality of EG(s) 17, thereby converting such raw data into player-usable data. Any data recognition and conversion tool may be used for this purpose.

According to a further embodiment of the present invention, the TS 11 may contain an Image Processing Module (IPM) that enables processing of image data received from EG 17. This IPM may incorporate an image recognition module together with audio data analysis software, thereby enabling the IPM to recognize, filter, format and/or analyze etc. raw image data streams from a plurality of EG(s) 17, thereby converting such raw data into player-usable data. Any data recognition and conversion tool may be used for this purpose.

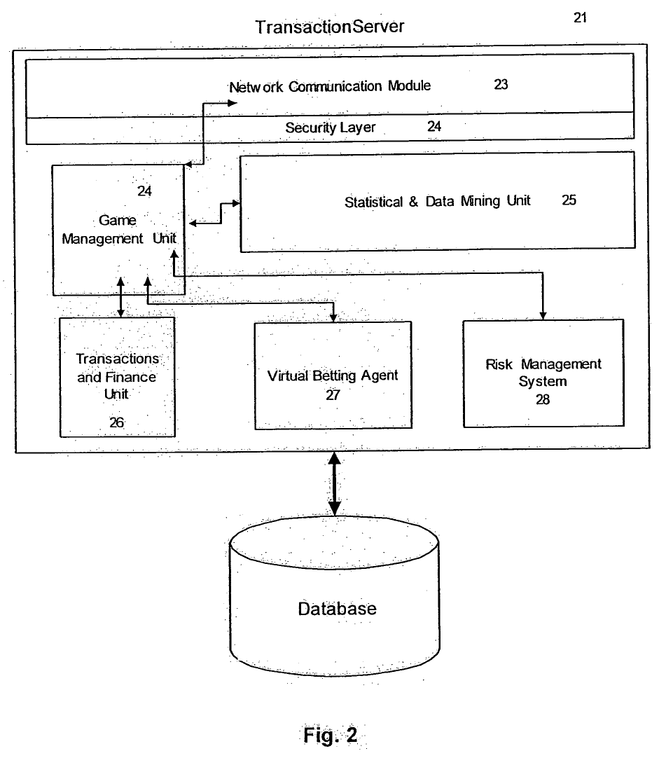

Reference is now made to FIG. 2, which illustrates the Transaction server (TS) 21 according to at least one additional embodiment of the present invention. The TS, 21 may contain a security layer 24 for enabling secure communication of data to and from the TS 21.

According to an additional embodiment of the present invention, the TS 21 may contain a Statistics and Data Mining Unit (SDMU) 25, for processing event data from a plurality of EG(s) 17 using statistical and data mining tools, such that raw or primary event data is converted to usable data for the players and the platform 10. There are many tools known in the art for undertaking statistical analysis and data mining on data. Such provision of gaming data may be provided to players on a continual and real-time basis. For example, the SDMU 25 may convert data results from video footage of a roulette game to useful information represented by graphs, tables or summary figures that illustrate winning/losing history and trends etc. in any number of individual gaming or gaming sessions. Another example is the usage by SDMU 25 of data mining tools to analyze gaming results from the “'x” number of recent games or rounds and recognize patterns which may be of use to players. Data recording and data mining applications are well known. Any data recording, data mining, statistical analysis methodology or systems known today or to be devised in the future are applicable to the present invention.

According to another embodiment of the present invention, the TS 21 may contain a Virtual Betting Agent (VBA) 27 for enabling personal configuration of gaming rules and conditions by players. The VBA 27 may be configured, for example, to limit the bid amounts, determine maximum game times, exiting criteria, profit and loss limits and any individual conditions (e.g. in “a” event, do “b”) etc. An example of a configuration of loss and profit limits is in the case where the player determines that his/her bids will be placed automatically, until such a time that a determined loss or profit limit has been reached, at which time the player's participation in a game may be automatically discontinued. Further examples of options enabled by the VBA 27 include selecting future bets on games/events and/or derivatives of games/events. For example, a player may use statistics to determine that game has more chance of winning the next 5 rounds than game 2. Player may then place a bet on game 1, against game 2, in relation to the results of the 5 upcoming rounds. Another example is where player desires to bid for a derivative occurrence in game 3, such as on the probability that the next card is “white”. In this way, players may configure rules for automatic betting based on actual game results or derivative information from game data, which is derived from analyzing game progress and/or results to develop new sets of events based on the probability of events happening. By enabling the above, the VBA 27 may provide a stock-exchange type of environment of individual events or games, where players may bet on the probabilities of particular events occurring or future successes of individual events, such that each individual event has a kind of market capital that may be bet on.

According to a further embodiment of the present invention, the VBA 27 may enable at least one player to play against at least one other player. This player-to-player option is particularly, but not only, relevant in the context of future bets, wherein players may bet against other players on the chances of selected events transpiring. The TS 11 may monitor the requests and references of a plurality of players, and optionally the combination of two or more players in player groups, thereby providing player(s)-to-player(s) betting opportunities. As in the typical player-House interactions, according to the present invention, betting occurs, results of events are acquired, and payments are implemented by the TS 11 according to the event results.

According to a further embodiment of the present invention, the TS 21 may contain a Risk Management System (RMS) 28, for enabling the House to manage event risks between various events and/or for the House operations as a whole. For example, the House may determine that any EG 17 that has lost more rounds than it has won within any 50 game routine must be discontinued, or that the entire house should cease activity if a certain amount of money has been lost in a determined period. The RMS 28 may enable the House to see the total exposure or risk at any given moment, and to cease activities at any moment, to limit bets or to freeze payouts etc.

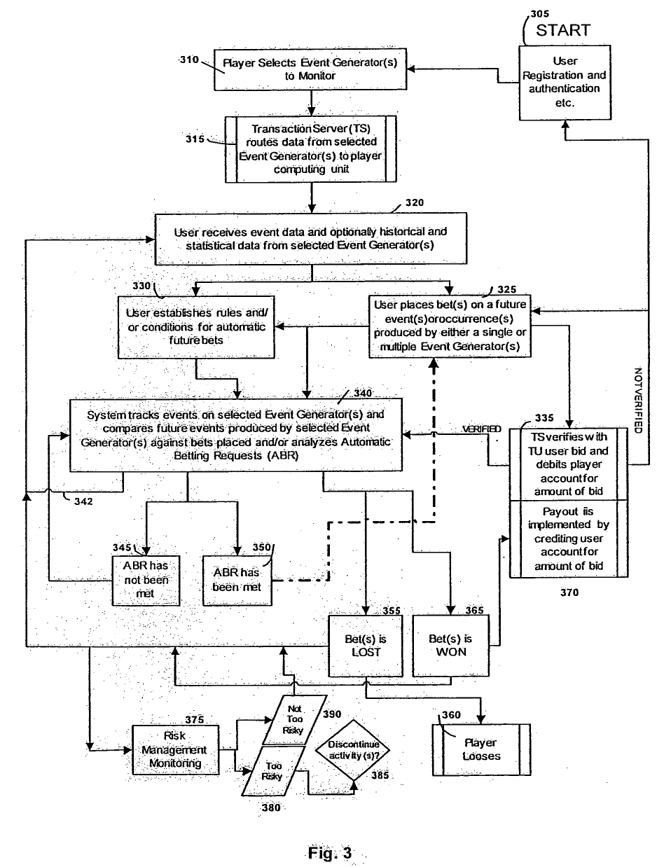

FIG. 3 is a flowchart that illustrates an example of steps performed according to at least one process of the present invention. As can be seen in the figure, user 19 initially registers with the system 305, and subsequently utilizes the platform front-end (such as a House Website, as presented by the GMU 24) to select 310 one or more EG(s) for monitoring. The registered player is typically required to log in to the platform 10, optionally by using a keyword, biometric data or any other necessary private code or key. The player 19 may subsequently view the various available events and/or manage his/her portfolio of gaming events, adding or deleting events in which he or she is playing or monitoring. Once the player determines, for examples which games he or she would like to monitor or play, the relevant data is routed from the selected is EG(s) to the player 19 computing device. This touting of event data is typically implemented by the GMU 24. The player 19 subsequently receives 320 event data, and optionally historical and statistical data, from selected Event generator(s) 17. He/she then places bet(s) 325 on a future event(s) or ongoing events produced by; either a single or multiple Event generator(s). These bets may be monetary and/or non-monetary: bets. Additionally or alternatively, the player 19 may establish rules and/or conditions 330 for automatic future bets, optionally using a Virtual Betting Agent (VBA) 27, for enabling personal configuration of gaming rules and/or conditions by players. Betting conditions may include, for example, bid ceilings, payout ceilings loss limits, time limits, and particular event limits etc. Particular event limits may include, for example, a rule that in the case of “x” wins by the House, player game is immediately suspended. After bets have been placed, TS 21 may authenticate the user and verify the user bid with the Transaction and, Finance Unit (TU) 26. The bid amount may be extracted from 335 the player's account or credit card etc, to confirm the bid placement.

In either of the above scenarios, the system subsequently tracks events on selected event generator(s) and compares generated (future) events produced by selected event generator(s) against bets placed, to derive bidding results and/or analyze Automatic Betting Requests (ABR) 340. The latter process determines whether the ABR(s) have or have not been met, and thereby indicates whether the player's conditions for the placing of a bid have been met. In the case where the ABR have not been met, the system continues tracking events or games 340, until such a: time as the ABR are met. When the ABR has been met, the system informs the user, and returns to request confirmation of bid placement by the player 325. The above event tracking and comparing processes 340, in the cases where bets have been placed, provide the results for the event(s) that the players have bid on. In the case where the bet is lost, the game ends 360. In the case where the bet is won, the payout, which may be a monetary or non-monetary payout, is generated, and the payout or game prize, whether monetary or non-monetary, may be transferred from the House to the player account 370. The player account may be a “money” account or a “non-money” account, where bonuses coupons, incentives etc, may be deposited and/or withdrawn. According to a further embodiment of the present invention, a conversion may be implemented, in any of the above gaming scenarios, to convert non-monetary deposits into monetary deposits, or non-monetary accounts into monetary accounts, or vice Versa. The user may be authenticated before the payout is made (credited) to the user's account. In the case where the user is not authenticated, the user may need to reregister or otherwise prove his/her identity 305. Alternatively, the player may return directly to step 325 and place one or more additional bets. The results of the event tracking and comparing processes 340 are typically sent to the user 342, enabling the user to determine if he/she wishes to continue interacting with the particular event played (i.e. step 320), without having to start from step 310.

According to at least one embodiment of the present invention, a Risk Management System (RMS) 28 may be provided to enable the House to determine risk limits. The RMS 28 may monitor 375 the results of steps 355 and/or 365 (which relate to the event results) or any other steps in at least one gaming process, from one or more EG(s) 17, to determine whether the House determined risk ceiling has been met for the House in general, or for one or more EG(s) 17. In the case where a determined risk limit has been met 380, TS 11 may act to discontinue 385 one or more activities, such as player bids or payouts, and/or the general functioning of the House, in accordance with the predetermined rules. In the case where a determined risk limit has not been met 390, the gaming process may be continued. The RMS 28 may monitor the House risk at any time, during all or any processes. The example illustrated in FIG. 3 is but one alternative of where the RMS 28 may implement monitoring.

According to at least one embodiment of the present invention, the receiving 320 of event data and (optionally) historical and statistical data from selected Event generator(s) 17 may be enabled by the Statistics and Data Mining Unit (SDMU) 25. The SDMU 25 may enable processing of event data from a plurality of EG(s) 17 using statistical and data mining tools, such that raw or primary gaming data may be converted to usable data for both the players and the platform 10.

According to at least one embodiment of the present invention, the establishment of rules and/or conditions 330 for automatic future bets may be implemented using a Virtual Betting Agent (VBA) 27. The VBA 27 may enable personal configuration of gaming rules and/or conditions by players.

According to a further embodiment of the present invention, a method is provided for enabling a land-based House to provide event betting to remote players. According to at least one version of this embodiment, as can be seen with reference to FIG. 1, the land-based House may convert at least one existing event or game into an EG 17. The land-based House may also provide a TS 11. The EG 17 may subsequently transfers event results to the TS 11, using a network, whereby the events may be processed and transferred to one or more remote players 19. The remote players 19 may subsequently interact with the existing events, by monitoring events, analyzing event statistics, and placing bets and/or setting betting conditions and rules using a GUI provided by the TS 11.

According to a further embodiment of the present invention, a method is provided for enabling a non-monetary gaming platform, wherein step 335 is ignored. In this case, once the user has placed a bid, the system may automatically track the selected events 340, without requiring financial verification.

According to a further embodiment of the present invention, a method is provided for enabling the data and/or results of at least one event generator 17 to be at least partially owned, possessed or otherwise purchased by at least one user, whether the user is an individual, group, partnership, company, incorporation or any other entity, and whether the user is participating in the events or not participating in the events. This embodiment thereby enables users to have interests or rights in the data and/or results of at least one Event generator 17.

The foregoing description, of the embodiments of the invention has been presented for the purposes of illustration and description. It will be appreciated that the present invention is not limited by what has been described hereinabove and that numerous modifications, all of which fall within the scope of the present invention, exist. For example, while the present invention has been described with respect to an online gaming platform, the scope of the present invention includes the setting up of an online gaming platform, for enabling monitoring and participating in a plurality of simultaneous games.

It will be appreciated by persons skilled in the art that the present invention is not limited by what has been particularly shown and described herein above. Rather the scope of the invention is defined by the claims that follow.

What is claimed:

1. An online gaming system comprising:
a transaction server (TS);
a database; and
one or more event generators (EG),
wherein said TS utilizes results from said at least one EG to enable remote player interaction with at least one actual and/or virtual event.

2. The system according to claim 1, further comprising a monitoring device to monitor said event generator and to convey a signal to said transaction server indicating one or more game events from said event generator.

3. The system according to claim 2, wherein said monitoring device is selected from the group consisting of a image collecting device, a sound collecting device, a video collecting device, a video camera, a digital table reader, a microphone and an spinning angular decoder.

4. The system according to claim 2, wherein said event generator is selected from the group consisting of a computer application simulating a roulette table, a real roulette table, a computer application simulating a slot machine, a real slot machine, a computer application simulating a chance-based game, a real chance-based game, a computer application simulating a blackjack game, a real blackjack game, a computer application simulating a baccarat game, and a real baccarat game.

5. The systems according to claim 4, wherein said transaction server comprises one or more risk management systems adapted to stop the acceptance of bets should said risk management system determine that exposure to loss exceeds some value.

6. The system according to claim 4, wherein said transaction server further comprises a virtual betting agent, wherein said virtual betting agent is adapted to receive betting instructions from a user for one or more game events to take place in the future and to make the instructed bets at some appropriate point prior to the one or more game events to take place in the future.

7. The system according to claim 6, wherein said virtual betting agent is adapted to receive contingent betting instructions to make one or more bets on one or more event generators contingent upon one or more events taking place.

8. The system according to claim 7, wherein said contingent event may be one or more game events on one or more game event generators.

9. The system according to claim 4, wherein said transaction server comprises a statistical data mining unit adapted to provide a user with historic data and or event statistic on one or more event generators or on the player's own betting history.

10. The system according to claim 8, wherein a player may use the statistical data mining unit in making gaming decisions.

11. An online gaming method comprising:
selecting an event to monitor, from at least one event generator;
transferring event data for chosen event(s) to a transaction server,
transferring processed event data for chosen event(s) to at least one player;
selecting at least one bid for at least one chosen event;
crediting player account for amount of said at least one bid; and
implementing payout according to actual results of said at least one event.
